(19) United States
(12) Patent Application Publication
(10) Pub. No.: US 2006/0135045 A1
(43) Pub. Date: Jun. 22, 2006

(54) Polishing compositions for reducing erosion in semiconductor wafers

(76) Inventors: Jinru Bian, Newark, DE (US); Raymond Lee Lavoie JR., Elkton, MD (US); John Quanci, Haddonfield, NJ (US); Qianqiu Ye, Wilmington, DE (US)

Correspondence Address: Rohm and Haas;Electronic Materials CMP Holdings, Inc., Suite 1300, 1105 North Market Street, Wilmington, DE, 19899, US

(21) Appl. No.: 11/015,528

(22) Filed: Dec. 17, 2004

(51) Int. Cl. B24B 1/00; C09K 3/14

(52) U.S. Cl. 451/36; 51/308

(57) ABSTRACT

The aqueous polishing composition is useful for polishing semiconductor substrates. The polishing solution comprises 0.001 to 2 wt % of a polyvinylalcohol copolymer, the polyvinylalcohol copolymer having a first component, a second component and a weight average molecular weight of 1,000 to 1,000,000 grams/mole, and the first component being 50 to 95 mole percent vinyl alcohol and the second component being more hydrophobic than the vinyl alcohol and 0.05 to 50 wt % silica abrasive particles; and the composition having a pH of 8 to 12.

### BACKGROUND OF THE INVENTION

This disclosure relates to the polishing of semiconductor wafers and more particularly, to polishing compositions and methods for removing barrier materials of semiconductor wafers in the presence of underlying dielectric layers with reduced damage to the dielectric layer.

The semiconductor industry uses interconnect metals in forming integrated circuits on semiconductor wafers. These interconnect metals are preferably non-ferrous metals. Suitable examples of such non-ferrous interconnects are aluminum, copper, gold, nickel, and platinum group metals, silver, tungsten and alloys comprising at least one of the foregoing metals. These interconnect metals have a low electrical resistivity. Copper metal interconnects provide excellent conductivity at a low cost. Because copper is highly soluble in many dielectric materials, such as silicon dioxide or doped versions of silicon dioxide, integrated circuit fabricators typically apply a diffusion barrier layer to prevent the copper diffusion into the dielectric layer. For example, barrier layers for protecting dielectrics include, tantalum, tantalum nitride, tantalum-silicon nitrides, titanium, titanium nitrides, titanium-silicon nitrides, titanium-titanium nitrides, titanium-tungsten, tungsten, tungsten nitrides and tungsten-silicon nitrides.

In the manufacturing of semi-conductor wafers, polishing compositions are used to polish semiconductor substrates after the deposition of the metal interconnect layers. Typically, the polishing process uses a “first-step” slurry specifically designed to rapidly remove the metal interconnect. The polishing process then includes a “second-step” slurry to remove the barrier layer. The second-step slurries selectively remove the barrier layer without adversely impacting the physical structure or electrical properties of the interconnect structure. In addition to this, the second step slurry should also possess low dishing for dielectrics. Erosion refers to unwanted recesses in the surface of dielectric layers that results from removing some of the dielectric layer during the polishing process. Erosion that occurs adjacent to the metal in trenches causes dimensional defects in the metal interconnects as well. These defects contribute to attenuation of electrical signals transmitted by the circuit interconnects and impair subsequent fabrication. For purposes of this specification, removal rate refers to a removal rate as change of thickness per unit time, such as, Angstroms per minute.

U.S. Pat. No. 6,443,812 to Costas et al., discloses a polishing composition comprising an organic polymer having a backbone comprising at least 16 carbon atoms, the polymer having a plurality of moieties with affinity to surface groups on the semiconductor wafer surface. The polishing composition does not, however, prevent dishing of the low-k dielectric layer and does not recognize controlling the removal rate of the low-k dielectric materials. The composition further does not recognize tuning of the slurry.

There remains an unsatisfied demand for aqueous polishing compositions that can selectively remove barrier layers while simultaneously reducing dishing and additionally permitting control of the removal rate of the low-k dielectric and ultra low-k dielectric layer.

### STATEMENT OF THE INVENTION

An aspect of the invention includes an aqueous polishing composition for polishing semiconductor substrates comprising: 0.001 to 2 wt % of a polyvinylalcohol copolymer, the polyvinylalcohol copolymer having a first component, a second component and a weight average molecular weight of 1,000 to 1,000,000 grams/mole, and the first component being 50 to 95 mole percent vinyl alcohol and the second component being more hydrophobic than the vinyl alcohol and 0.05 to 50 wt % silica abrasive particles; and the composition having a pH of 8 to 12.

In another aspect of the invention, the invention provides an aqueous polishing composition for polishing semiconductor substrates comprising: 0.01 to 1.7 wt % of a polyvinylalcohol-polyvinylacetate copolymer, the polyvinylalcohol-polyvinylacetate copolymer having 60 to 90 mole percent vinyl alcohol and a weight average molecular weight of 1,000 to 1,000,000 grams/mole, 0 to 10 wt % corrosion inhibitor, 0 to 10 wt % oxidizing agent, 0 to 20 wt % complexing agent and 0.1 to 40 wt % silica abrasive particles; and the composition having a pH of 8 to 11.

In another aspect, the invention provides a method of polishing a semiconductor substrate comprising: applying an aqueous polishing composition of 0.001 to 2 wt % of a polyvinylalcohol copolymer, the polyvinylalcohol copolymer having a first component, a second component and a weight average molecular weight of 1,000 to 1,000,000 grams/mole, and the first component being vinyl alcohol and the second component being more hydrophobic than the vinyl alcohol and 0.05 to 50 wt % silica abrasive particles; and the composition having a pH of 8 to 12; and polishing the semiconductor substrate at a pad pressure less than or equal to 21.7 kiloPascals.

### DESCRIPTION OF FIGURES

FIG. 1 is a graphical plot showing the removal rate for the comparative polishing composition containing different amounts of polyvinylpyrrolidone;

FIG. 2 is a graphical plot showing the removal rate for polishing compositions containing different amounts of polyvinylalcohol copolymer. The polishing pad used was IC1010™ supplied by Rohm and Haas Electronics Materials CMP Technologies; and

FIG. 3 is a graphical plot showing the removal rate for polishing compositions containing different amounts of polyvinylalcohol copolymer. The polishing pad used was POLITEX™ supplied by Rohm and Haas Electronics Materials CMP Technologies.

### DETAILED DESCRIPTION OF PREFERRED EMBODIMENTS

The polyvinylalcohol copolymer has a first component of 50 to 95 mole percent vinyl alcohol and a second component that is more hydrophobic than the vinyl alcohol component. For purposes of this specification, more hydrophobic refers to a greater “dislike” of water or a lower solubility in water than polyvinylalcohol. In one embodiment, the polyvinylalcohol copolymer has 60 to 90 mole percent vinyl alcohol component. A preferred polyvinylalcohol copolymer has 70 to 90 mole percent vinyl alcohol component. The mole percent is based on the total number of moles of vinyl alcohol in the copolymer. If the mole percent of vinyl alcohol component is too low, then the polyvinylalcohol copolymer loses its water solubility. If the mole percent of vinyl alcohol component is too high, then the polyvinylalcohol copolymer loses its effectiveness. Preferably, the polyvinylalcohol copolymer is a polyvinylalcohol-polyvinylacetate copolymer, for ease of manufacture and effectiveness.

The polyvinylalcohol copolymer has a weight average molecular weights of 1,000 to 1,000,000 grams/mole as determined by gel permeation chromatography (GPC). In one embodiment, the polyvinylalcohol copolymer has a weight average molecular weight of 3,000 to 500,000 grams/mole. In another embodiment, the polyvinylalcohol copolymer has a weight average molecular weight of 5,000 to 100,000 grams/mole. In yet another embodiment, the polyvinylalcohol copolymer has a weight average molecular weight of 10,000 to 30,000 grams/mole. A preferred weight average molecular weight for the polyvinylalcohol copolymer is 13,000 to 23,000 grams/mole. Another preferred weight average molecular weight for the polyvinylalcohol copolymer is 85,000 to 146,000 grams/mole. It is to be noted that for purposes of this specification, all ranges are inclusive and combinable.

The polyvinylalcohol copolymer is present in amounts of 0.001 to 2 wt %. In one embodiment, the polyvinylalcohol copolymer is present in amounts of 0.01 to 1.7 wt %. In another embodiment, the polyvinylalcohol copolymer is present in amounts of 0.1 to 1.5 wt %. As used herein, and throughout this specification, the respective weight percents are based on the total weight of the polishing composition. Polyvinylalcohol-polyvinylacetate copolymers having weight average molecular weights of 13,000 to 23,000 grams/mole and a degree of hydrolysis of either 87 to 89 mole percent or 96 mole percent are commercially available from Aldrich Chemical Company. Similarly, polyvinylalcohol-polyvinyl acetate copolymers having weight average molecular weights of 85,000 to 146,000 grams/mole and a degree of hydrolysis of either 87 to 89 mole percent or 96 mole percent are also commercially available from Aldrich Chemical Company.

The slurries operate with a zeta potential between −40 mV and −1 5 mV. The polyvinylalcohol copolymer provides at least a 2 millivolt increase in zeta potential to the slurry. Although increasing the zeta potential decreases the slurries' stability, it also decreases the slurries' low-k removal rate. Preferably, the slurries' polyvinylalcohol copolymer provides at least a 5 millivolt increase in zeta potential. Unfortunately, this increase in zeta potential can have an adverse impact on the long term stability of the polishing slurry.

In addition to the polyvinylalcohol copolymer other thermoplastic polymers may be optionally used in the polishing composition. Thermoplastic polymers that may optionally be used in the polishing composition are oligomers, polymers, ionomers, dendrimers, copolymers such as block copolymers, graft copolymers, star block copolymers, random copolymers, or the like, or mixtures comprising at least one of the foregoing polymers. Suitable examples of thermoplastic polymers that can be used in the polishing composition are polyacetals, polyacrylics, polycarbonates, polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinylalcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like, or mixtures thereof.

Blends of thermoplastic polymers may also be used. Examples of blends of thermoplastic polymers include acrylonitrile-butadiene-styrene/nylon, polycarbonate/acrylonitrile-butadiene-styrene, acrylonitrile butadiene styrene/polyvinyl chloride, polyphenylene ether/polystyrene, polyphenylene ether/nylon, polysulfone/acrylonitrile-butadiene-styrene, polycarbonate/thermoplastic urethane, polycarbonate/polyethylene terephthalate, polycarbonate/polybutylene terephthalate, thermoplastic elastomer alloys, nylon/elastomers, polyester/elastomers, polyethylene terephthalate/polybutylene terephthalate, acetal/elastomer, styrene-maleicanhydride/acrylonitrile-butadiene-styrene, polyether etherketone/polyethersulfone, polyethylene/nylon, polyethylene/polyacetal, and the like, and mixtures comprising at least one of the foregoing blends of thermoplastic polymers.

The weight average molecular weight of the thermoplastic polymer is 100 to 1,000,000 grams/mole as determined by GPC. In one embodiment, the thermoplastic polymers have a weight average molecular weight of 500 to 500,000 grams/mole. In another embodiment, the thermoplastic polymers have a weight average molecular weight of 1,000 to 250,000 grams/mole. In yet another embodiment, the thermoplastic polymers have a weight average molecular weight of 5,000 to 100,000 grams/mole. An exemplary weight average molecular weight for the thermoplastic polymer is 8,000 to 12,000 grams/mole, with a weight average molecular weight of 10,000 grams/mole being most preferred.

The addition of the polyvinylalcohol copolymer as well as the optional thermoplastic polymers to the polishing composition provides the polished surface of the semiconductor substrate with a reduced surface roughness and fewer scratches than when the polishing composition is used without thermoplastic polymers. For purposes of this specification, removal rate refers to a change of thickness per unit time, such as, Angstroms per minute. The thermoplastic polymer is generally present in the polishing composition in an amount of 0.001 to 1 wt %. In one embodiment, the thermoplastic polymer is present in an amount of 0.01 to 0.85 wt %. In another embodiment, the thermoplastic polymer is present in an amount of 0.1 to 0.75 wt %.

If a thermoplastic polymer is used, it is desirable to utilize the polyvinylalcohol copolymer and the thermoplastic polymer in a weight ratio of 1:10 to 100:1 respectively. In one embodiment, it is desirable to utilize the polyvinylalcohol copolymer and the thermoplastic polymer in a weight ratio of 1:5 to 50:1 respectively. In another embodiment, it is desirable to utilize the polyvinylalcohol copolymer and thermoplastic polymer in a weight ratio of 1:5 to 60:1 respectively. In yet another embodiment, it is desirable to utilize the polyvinylalcohol copolymer and the thermoplastic polymer in a weight ratio of 1:3 to 10:1 respectively.

The polishing composition advantageously includes a silica abrasive for “mechanical” removal of cap layers and barrier layers. The abrasive is preferably a colloidal abrasive.

The abrasive has an average particle size of less than or equal to 200 nanometers (run) for preventing excessive metal dishing and erosion. For purposes of this specification, particle size refers to the average particle size of the abrasive. It is desirable to use an abrasive having an average particle size of less than or equal to 100 nm, and preferably less than or equal to 75 nm. The least metal dishing and erosion advantageously occurs with silica having an average particle size of 10 to 75 mn. Most preferably, the silica has an average particle size of 20 to 50 nm. In addition, the preferred abrasive may include additives, such as dispersants to improve the stability of the abrasive. One such abrasive is colloidal silica from Clariant S.A., of Puteaux, France. If the polishing composition does not contain abrasives, then pad selection and conditioning becomes more important to the polishing process. For example, for some silica-free compositions, a fixed abrasive pad improves polishing performance.

A low abrasive concentration can improve the polishing performance of a polishing process by reducing undesired abrasive induced defects, such as scratching. By employing an abrasive having a relatively small particle size and formulating the polishing composition at a low abrasive concentration, better control can be maintained over the removal rate for the non-ferrous metal interconnect and the low-k dielectric. It is desired to use the abrasive in an amount of 0.05 wt % to 50 wt %. In one embodiment, it is desired to use the abrasive in an amount of 0.1 to 40 wt %. In another embodiment, it is desired to use the abrasive in an amount of 0.5 to 30 wt %. In yet another embodiment, it is desirable to use the abrasive in an amount of 1 to 25 wt %.

It is desirable to include 0 to 10 wt % oxidizing agent in the polishing composition for facilitating the removal of non-ferrous metal interconnects such as aluminum, aluminum alloys, copper, copper alloys, gold, gold alloys, nickel, nickel alloys, platinum group metals, platinum group alloys, silver, silver alloys, tungsten and tungsten alloys or mixtures comprising at least one of the foregoing metals. Suitable oxidizing agents include, for example, hydrogen peroxide, monopersulfates, iodates, magnesium perphthalate, peracetic acid and other peracids, persulfates, bromates, periodates, nitrates, iron salts, cerium salts, manganese (Mn) (III), Mn (IV) and Mn (VI) salts, silver salts, copper salts, chromium salts, cobalt salts, halogens, hypochlorites, and mixtures comprising at least one of the foregoing oxidizers. The preferred oxidizer is hydrogen peroxide. It is to be noted that the oxidizer is occasionally added to the polishing composition just prior to use and in such instances the oxidizer is contained in a separate package. In one embodiment, the oxidizing agent is present in an amount of 0.1 to 10 wt %. In another embodiment, the oxidizing agent is present in an amount of 0.2 to 5 wt %.

The polishing composition also advantageously comprises a corrosion inhibitor, also commonly termed a film-forming agent. The corrosion inhibitor may be any compound or mixtures of compounds that are capable of chemically binding to the surface of a substrate feature to form a chemical complex wherein the chemical complex is not a metal oxide or hydroxide. The chemical complex acts as a passivating layer and inhibits the dissolution of the surface metal layer of the metal interconnect.

The preferred corrosion inhibitor is benzotriazole (BTA). In one embodiment, the polishing composition may contain a relatively large quantity of BTA inhibitor for reducing the interconnect removal rate. The inhibitor is present in an amount of 0 to 10 wt %. In one embodiment, the inhibitor is present in an amount of 0.025 to 4 wt %. In another embodiment, the inhibitor is present in an amount of 0.25 to 1 wt %. When BTA is used, it can be used in a concentration of up to the limit of solubility in the polishing composition, which may be up to 2 wt % or the saturation limit in the polishing composition. The preferred concentration of BTA is an amount of 0.0025 to 2 wt %. Optionally, a supplementary corrosion inhibitor may be added to the polishing composition. For example, an addition of imidazole, such as, 0.1 to 5 wt % (preferably 0.5 to 3 wt %) can further increase copper removal rate without a significant impact upon other removal rates.

Supplementary corrosion inhibitors are surfactants such as, for example, anionic surfactants, nonionic surfactants, amphoteric surfactants and polymers, or organic compounds such as azoles. In addition, azoles may be used to toggle the copper removal rate. For example, the supplementary inhibitor may include an imidazole, tolytriazole or a mixture thereof in combination with BTA. The addition of tolytriazole reduces the copper removal rate, while the addition of imidazole increases the copper removal rate. Preferred supplementary inhibitors include mixtures of tolytriazole with BTA or imidazoles with BTA. In one embodiment, the inhibitor may comprise additional polymers or surfactants in addition to an azole inhibitor to facilitate control of the copper removal rate.

The polishing composition has a basic pH to toggle the metal interconnect removal rate or the low-k or ultra low-k dielectric rate as desired. It is generally desirable for the polishing composition to have a pH of 8 to 12. In one embodiment, the pH of the polishing composition may be 8 to 11. Most preferably, the pH is 9 to 11. If pH is too low, then the silica can lose stability; and if pH is too high, the slurry can be hazardous and difficult to control. The polishing composition also includes an inorganic or an organic pH adjusting agent to vary the pH of the polishing composition. Suitable acidic pH adjusting agents include, for example, nitric acid, sulfuric acid, hydrochloric acid, phosphoric acid, and the like, and mixtures comprising at least one of the foregoing acidic pH adjusting agents. The preferred pH adjusting agent is nitric acid. Basic pH adjusting agents may also be used in the polishing composition. Suitable examples of pH adjusting agents are sodium hydroxide, ammonium hydroxide, potassium hydroxide, and the like, as well as mixtures comprising at least one of the foregoing basic pH adjusting agents. The balance of the aqueous composition is water and preferably deionized water.

Optionally, the polishing composition may contain 0 to 20 wt % chelating or complexing agent to adjust the copper removal rate relative to the barrier metal removal rate. The chelating or complexing agent improves the copper removal rate by forming a chelated metal complex with copper. Exemplary complexing agents for optional use in the polishing fluid include acetic acid, citric acid, ethyl acetoacetate, glycolic acid, lactic acid, malic acid, oxalic acid, salicylic acid, sodium diethyl dithiocarbamate, succinic acid, tartaric acid, thioglycolic acid, glycine, alanine, aspartic acid, ethylene diamine, trimethylene diamine, malonic acid, glutaric acid, 3-hydroxybutyric acid, propionic acid, phthalic acid, isophthalic acid, 3-hydroxy salicylic acid, 3,5-dihydroxy salicylic acid, gallic acid, gluconic acid, pyrocatechol, pyrogallol, gallic acid, tannic acid, mixtures thereof and salts thereof. Preferably, the complexing agent used in the polishing fluid is citric acid. Most preferably, the polishing fluid comprises 0 to 15 weight percent of the complexing or chelating agent.

Optionally, the polishing composition can also include buffering agents such as various organic and inorganic acids, and amino acids or their salts with a pKa that is greater than or equal to 5. Optionally, the polishing composition can further include defoaming agents, such as non-ionic surfactants including esters, ethylene oxides, alcohols, ethoxylate, silicon compounds, fluorine compounds, ethers, glycosides and their derivatives, and mixtures comprising at least one of the foregoing surfactants. The defoaming agent may also be an amphoteric surfactant. The polishing composition can also optionally include pH buffers, biocides and defoaming agents.

It is generally preferred to use the polishing composition on semiconductor substrates having non-ferrous interconnects. Suitable metals used for the interconnect include, for example, aluminum, aluminum alloys, copper, copper alloys, gold, gold alloys, nickel, nickel alloys, platinum group metals, platinum group alloys, silver, silver alloys, tungsten and tungsten alloys or mixtures comprising at least one of the foregoing metals. The preferred interconnect metal is copper.

The polishing composition enables the polishing apparatus to operate with a low pressure of less than 21.7 kPa (3psi). The preferred pad pressure is 3.5 to 21.7 kPa (0.5 to 3 (psi)). Within this range, a pressure of less than or equal to 13.8 kPa (2 psi), more preferably less than or equal to 10.3 kPa (1.5 psi), and most preferably less than or equal to 6.9 kPa (1 psi) may be advantageously used. Most preferably, the polishing occurs with the polishing pad and conditions of the Example shown below. The low polishing pad pressure improves polishing performance by reducing scratching and other undesired polishing defects and reduces damage to fragile materials. For example, low dielectric constant materials fracture and delaminate when exposed to high stresses. The polishing compositions comprising the polyvinylalcohol copolymer advantageously permit high barrier layer and cap layer removal rates while facilitating control over the removal rates for the non-ferrous metal interconnect as well as the low-k and ultra-low-k dielectric layers derived from organic materials such as carbon doped oxides. In an exemplary embodiment, the polishing composition can be adjusted or tuned so as to advantageously achieve a high barrier removal rate without substantial damage to the low-k or ultra-low-k dielectric layer. The polishing compositions can be advantageously used to reduce erosion in patterned wafers having a variety of line widths.

The polishing composition has a tantalum nitride removal rate of up to four times greater than that of the copper removal rate at a pad pressure of 3.5 to 21.7 kPa as measured with a polishing pad pressure measured normal to an integrated circuit wafer and using a porous polyurethane or polyurethane-containing polishing pad. The polishing composition has a tantalum nitride removal rate of greater than or equal to one time that of the low-k dielectric removal rate at a pad pressure of 3.5 to 21.7 kPa as measured with a polishing pad pressure measured normal to an integrated circuit wafer and using a porous polyurethane polishing pad. A particular polishing pad useful for determining selectivity is the IC1010™ porous-filled polyurethane polishing pad. It is preferred to conduct the polishing with a porous polyurethane pad. The polishing compositions can be created before or during the polishing operation. If created during the polishing operation, the polishing fluid can be introduced into a polishing interface and then some or all of the particles can be introduced into the polishing interface by means of particle release from a polishing pad.

Some embodiments of the invention will now be described in detail in the following Examples.

### EXAMPLES

### Example 1

The nomenclature for the materials used in the polishing compositions for the following examples are shown in Table 1 below. The Klebosol 1501-50 is a silica available from Clariant, having 30 wt % silica particles of average size equal to 50 nm and a pH of 10.5 to 11. In the Examples, numerals represent examples of the invention and letters represent comparative examples. The sample is diluted down to 12 wt % silica particles by using deionized water. The polyvinylalcohol-polyvinylacetate copolymer was from Aldrich having a molecular weight of either 13,000 to 23,000 g/mole or 85,000 to 146,000 and a degree of hydrolyzation of either 87-89 mole% or 96 mole% (Comparative Examples C and D).

This example was undertaken to demonstrate that a polishing composition comprising polyvinylpyrrolidone and polyvinylalcohol-polyvinylacetate copolymer can be effectively used to vary the copper removal rate while reducing the removal rate for the low-k and ultra low-k dielectrics such as a carbon doped oxide. Comparative polishing compositions having only polyvinylpyrrolidone were also tested. In this example, several polishing compositions were prepared with different polyvinylalcohol-polyvinylacetate copolymer (PVA-PVAC) or polyvinylpyrrolidone (PVP) concentrations. The polyvinylalcohol copolymer used in Example 1 had a molecular weight of 13,000 to 23,000 g/mole and a degree of hydrolyzation of 87 to 89 mole percent. The compositions for the respective formulations are shown in the Table 2. To each of the respective formulations were added ammonium chloride (NH₄Cl) in an amount of 0.01 wt %, a biocide e.g., Kordek in an amount of 0.05 wt % and 0.8 wt % active hydrogen peroxide. The pH of all polishing compositions shown in Table 2 was 9 and the pH was adjusted to 9 by the addition of potassium hydroxide. Deionized water constituted the remainder of the composition.

Polishing experiments were performed using polishing equipment having model number 6EC supplied by Strasbaugh. The polishing pad was either an IC1010™ porous-filled polyurethane polishing pad or a POLITEX pad supplied by Rohm and Haas Electronics Materials CMP Technologies. The pad was conditioned prior to each run. The polishing process was performed at a pressure of 13.78 kPa (2 psi), a table speed of 120 revolutions per minute (rpm) and a carrier speed of 114 rpm. The polishing composition supply rate (slurry flow rate) was 200 milliliters/minute (ml/min). All tests employed 200 mm blanket wafers.

TABLE 1

| | | | | | Neolone ™ | |
|---|---|---|---|---|---|---|
| | CA | BTA | Silica | NH₄Cl | Biocide | PVP |
| Sample # | (wt %) | (wt %) | (wt %) | (wt %) | (wt %) | (wt %) |
| A | 0.30 | 0.05 | 12 | 0.01 | 0.05 | 0.1-0.6 |

CA = citric acid,
BTA = benzotriazole,
PVP = polyvinylpyrrolidone and
Neolone biocide = 50.0-52.0% methyl-4-isothiazolin-3-one, 45.0-47.0% Proanediol and <3% related reaction product.

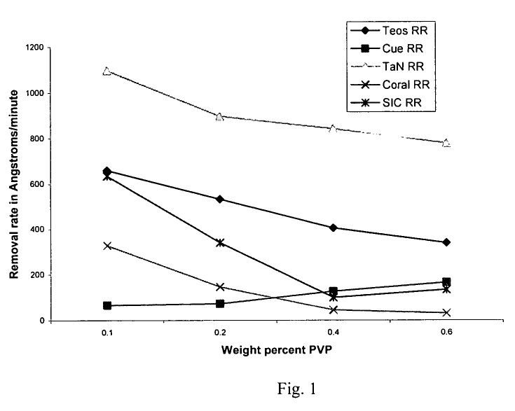

FIG. 1 is a graphical plot showing the removal rate for the comparative polishing composition A containing different amounts of polyvinylpyrrolidone. The removal rate is measured in Angstroms per minute. From the plot it may be seen that while the cap layer (TEOS) removal rate and the barrier layer (TaN) removal rate are decreased with an increase in the weight percent of the polyvinylpyrrolidone in the polishing composition, the interconnect (copper) removal rate also substantially increases.

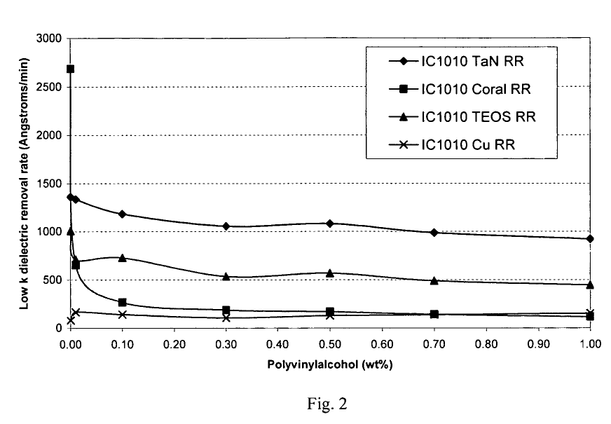

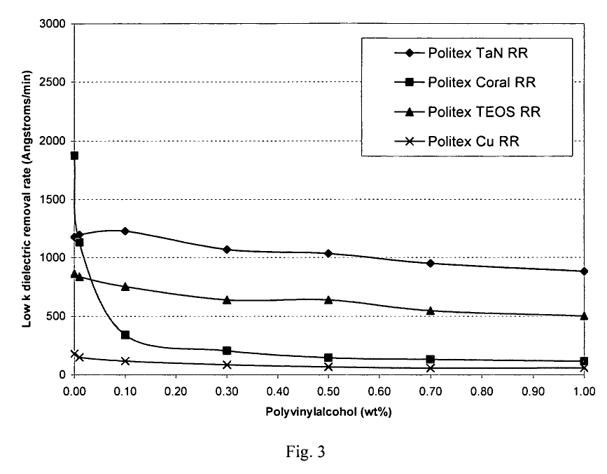

FIGS. 2 and 3 are graphical plots showing the removal rate for polishing compositions containing different amounts of polyvinylalcohol copolymer. The experiments detailed in FIG. 2 were conducted using the IC₁₀₁₀™ polishing pad (Table 3), while those detailed in FIG. 3 were conducted using the POLITEX TM polishing pad (Table 4).

TABLE 2

| Slur- | | Citric | PVA- | | Neolone | Final | 1501- | |
|---|---|---|---|---|---|---|---|---|
| ry | NH₄Cl | Acid | PVAC* | BTA | Biocide | pH | 50 | H₂O₂ |
| B | 0.01 | 0.300 | 0.000 | 0.0500 | 0.005 | 9.00 | 12.0 | 0.8 |
| 1 | 0.01 | 0.300 | 0.01 | 0.0500 | 0.005 | 9.00 | 12.0 | 0.8 |
| 2 | 0.01 | 0.300 | 0.1 | 0.0500 | 0.005 | 9.00 | 12.0 | 0.8 |
| 3 | 0.01 | 0.300 | 0.3 | 0.0500 | 0.005 | 9.00 | 12.0 | 0.8 |
| 4 | 0.01 | 0.300 | 0.5 | 0.0500 | 0.005 | 9.00 | 12.0 | 0.8 |
| 5 | 0.01 | 0.300 | 0.7 | 0.0500 | 0.005 | 9.00 | 12.0 | 0.8 |
| 6 | 0.01 | 0.300 | 1 | 0.0500 | 0.005 | 9.00 | 12.0 | 0.8 |

*Polyvinylalcohol-polyvinylacetate copolymer (PVA-PVAC) with a 10,000 g/mol molecular weight and an 80% degree of hydrolysis.

TABLE 3
1010 Hard Polyurethane Polishing Pad Data

| | | | | TaN | CDO | CDO | CDO | | TEOS | TEOS | | | Cu |
|---|---|---|---|---|---|---|---|---|---|---|---|---|---|
| Wafer | Slurry | TaN RR | TaN STD | %-NU | RR | STD | %-NU | TEOS RR | STD | %-NU | Cu RR | Cu STD | %-NU |
| 1 | A | 1323 | 62 | 4.7% | 2865 | 500.80 | 17.5 | 1079 | 151 | 14.0 | 81 | 66 | 81.5% |
| 2 | 6 | 923 | 47 | 5.1% | 115 | 23.55 | 20.5 | 446 | 60 | 13.4 | 152 | 58 | 37.8% |
| 3 | 5 | 988 | 56 | 5.7% | 142 | 26.55 | 18.7 | 489 | 73 | 14.9 | 689 | 64 | 9.3% |
| 4 | 3 | 1056 | 65 | 6.1% | 188 | 31.43 | 16.7 | 536 | 113 | 21.0 | 107 | 40 | 37.8% |
| 5 | 1 | 1332 | 80 | 6.0% | 655 | 124.24 | 19.0 | 709 | 1122 | 158.2 | 167 | 50 | 29.8% |
| 6 | 2 | 1181 | 74 | 6.3% | 267 | 46.72 | 17.5 | 730 | 351 | 48.1 | 141 | 43 | 30.5% |
| 7 | 4 | 1081 | 101 | 9.3% | 171 | 27.67 | 16.2 | 570 | 84 | 14.8 | 129 | 35 | 27.3% |
| 8 | A | 1392 | 164 | 11.8% | 2510 | 376.77 | 15.0 | 931 | 123 | 13.2 | 80 | 43 | 53.7% |

RR = Removal rate in Angstroms per minute; and
CDO represents CORAL carbon-doped oxide manufactured by Novellus.

TABLE 4
Politex Soft Polyurethane Polishing Pad Data

| | | TaN | TaN | TaN | Coral | CDO | CDO | | | TEOS | | | Cu |
|---|---|---|---|---|---|---|---|---|---|---|---|---|---|
| Wafer | Slurry | RR | STD | %-NU | RR | STD | %-NU | TEOS RR | TEOS STD | %-NU | Cu RR | Cu STD | %-NU |
| 1 | A | 1131 | 56 | 5.0% | 1921 | 111.79 | 5.8 | 866 | 35 | 4.1 | 190 | 102 | 53.7% |
| 2 | 6 | 882 | 37 | 4.2% | 116 | 56.37 | 48.4 | 503 | 28 | 5.5 | 60 | 31 | 51.0% |
| 3 | 5 | 951 | 50 | 5.3% | 133 | 19.69 | 14.9 | 547 | 21 | 3.8 | 59 | 26 | 44.9% |
| 4 | 3 | 1070 | 38 | 3.6% | 205 | 22.91 | 11.2 | 640 | 24 | 3.8 | 86 | 32 | 37.7% |
| 5 | 1 | 1199 | 80 | 6.6% | 1133 | 90.68 | 8.0 | 837 | 32 | 3.8 | 150 | 28 | 18.6% |
| 6 | 2 | 1229 | 646 | 52.6% | 340 | 39.58 | 11.7 | 753 | 28 | 3.7 | 117 | 30 | 25.8% |
| 7 | 4 | 1036 | 91 | 8.7% | 146 | 21.65 | 14.8 | 639 | 27 | 4.2 | 68 | 36 | 52.7% |
| 8 | A | 1227 | 194 | 15.8% | 1831 | 94.33 | 5.2 | 865 | 31 | 3.6 | 171 | 29 | 17.1% |

RR = Removal rate in Angstroms per minute.

TABLE 5

| | | IC1010 Hard Polyurethane Polishing | | | | Politex Soft Polyurethane Polishing Pad | | | |
|---|---|---|---|---|---|---|---|---|---|
| Slurry | PVA | TaN RR | CDO RR | TEOS RR | Cu RR | TaN RR | CDO RR | TEOS RR | Cu RR |
| A | 0.00 | 1357 | 2687 | 1005 | 80 | 1179 | 1876 | 865 | 180 |
| 1 | 0.01 | 1332 | 655 | 709 | 167 | 1199 | 1133 | 837 | 150 |
| 2 | 0.10 | 1181 | 267 | 730 | 141 | 1229 | 340 | 753 | 117 |
| 3 | 0.30 | 1056 | 188 | 536 | 107 | 1070 | 205 | 640 | 86 |
| 4 | 0.50 | 1081 | 171 | 570 | 129 | 1036 | 146 | 639 | 68 |
| 5 | 0.70 | 988 | 142 | 489 | 138 | 951 | 133 | 547 | 59 |
| 6 | 1.00 | 923 | 115 | 446 | 152 | 882 | 116 | 503 | 60 |
| RR = Removal rate in Angstroms per minute; and | | | | | | | | | |
| CDO represents CORAL carbon-doped oxide manufactured by Novellus. | | | | | | | | | |

From FIGS. 2 and 3, it may be seen that both the barrier layer (TaN) and the cap layer (TEOS) removal rates gradually decrease with an increase in the amount of polyvinylalcohol copolymer in the polishing composition. The removal rate for the non-ferrous interconnect metal (copper) also decreases gradually up to an amount of about 0.20 wt % of polyvinylalcohol copolymer in the polishing composition. When the amount of ployvinylalcohol copolymer increases beyond 0.20 wt %, the removal rate of the non-ferrous interconnect metal remains relatively constant. The carbon doped oxide layer (low-k dielectric layer) removal rate decreases initially with the addition of the polyvinylalcohol copolymer up to an amount of 0.1 wt %, but stabilizes upon the addition of additional ployvinylalcohol copolymer to the composition.

Thus, FIGS. 2 and 3 show that the presence of polyvinylalcohol copolymer in the polishing composition facilitates control of the metal interconnect removal rate as well as the removal rate of the low-k or ultra-low-k dielectric layer. The Figures also further show that the reduced removal rates for the barrier and the cap layer can be maintained over fairly large concentrations of polyvinylalcohol copolymer in the polishing composition. Thus the polyvinylalcohol copolymer may be advantageously used to toggle the removal rate of the non-ferrous metal interconnect and the low-k or ultra-low-k dielectric layer.

### Example 2

This example was undertaken to demonstrate the effect of polyvinylalcohol copolymer weight fraction, degree of hydrolyzation and weight average molecular weight on the removal rate of the low-k dielectric layer as well as on the removal rate of the silicon carbonitride layer. The compositions for this example are shown in Table 3 below. As in Example 1, each sample shown in Table 3 contained ammonium chloride (NH₄Cl) in an amount of 0.01 wt %, a biocide e.g., Kordek in an amount of 0.05 wt % (active biocide) and 0.8 wt % active hydrogen peroxide. The pH of all polishing compositions shown in Table 2 was 9 and the pH was adjusted to 9 by the addition of potassium hydroxide. Deionized water constituted the remainder of the composition.

TABLE 6

| | Citric | | | | Kordek | PVA- |
|---|---|---|---|---|---|---|
| Slurry | Acid | BTA | Silica | NH₄Cl | Biocide | PVAC |
| No. | (wt %) | (wt %) | (wt %) | (wt %) | (wt %) | (wt %) |
| C | 0.30 | 0.04 | 20 | 0.01 | 0.05 | 0.05 |
| D | 0.30 | 0.04 | 20 | 0.01 | 0.05 | 0.05 |
| 7 | 0.30 | 0.04 | 20 | 0.01 | 0.05 | 0.2 |
| 8 | 0.30 | 0.04 | 20 | 0.01 | 0.05 | 0.2 |
| 9 | 0.30 | 0.04 | 20 | 0.01 | 0.05 | 0.05 |
| 10 | 0.30 | 0.04 | 20 | 0.01 | 0.05 | 0.2 |
| 11 | 0.30 | 0.04 | 20 | 0.01 | 0.05 | 0.05 |
| 12 | 0.30 | 0.04 | 20 | 0.01 | 0.05 | 0.05 |

Kordek biocide = 50.0-52.0% methyl-4-isothiazolin-3-one, 45.0-47.0% Proanediol and <3% related reaction product.

The polyvinylalcohol-polyvinylacetate copolymer present in Samples 7-12, had a weight average molecular weight of either 13,000 to 23,000 g/mole or 85,000 to 146,000 g/mole. The degree of hydrolyzation for these polyvinylalcohol copolymer samples was either 87 to 89 mole percent or 96 mole percent as indicated in Table 7 below. Table 7 also demonstrates the polishing results for tests conducted in a manner similar to those documented in Example 1.

TABLE 7

| Slur- | | PVA-PVAC | Degree of | CDO | SiCN |
|---|---|---|---|---|---|
| ry | Polishing | Molecular Weight | Hydrolysis | RR | RR |
| No. | Pad | (Mole Percent) | (%) | (Å/Min.) | (Å/Min.) |
| C | VP3000 | 85,000-146,000 | 96 | 1020 | 896 |
| D | Politex | 85,000-146,000 | 96 | 1432 | 925 |
| 7 | VP3000 | 13,000-23,000 | 87-89 | 148 | 370 |
| 8 | VP3000 | 85,000-146,000 | 87-89 | 238 | 427 |
| 9 | Politex | 13,000-23,000 | 87-89 | 248 | 530 |
| 10 | Politex | 85,000-146,000 | 87-89 | 344 | 590 |
| 11 | VP3000 | 85,000-146,000 | 87-89 | 257 | 678 |
| 12 | Politex | 85,000-146,000 | 87-89 | 613 | 788 |

CDO represents CORAL carbon-doped oxide manufactured by Novellus.

The VP-3000™ pad is a porous polyurethane-containing pad manufactured by Rohm and Haas Electronics Materials CMP Technologies. From the Table 7, it may be seen that the molecular weight, the degree of hydrolysis and the concentration of polyvinylalcohol copolymer may be used to control the removal rate of the low-k dielectric layer. For example, Slurry 7, which has a polyvinylalcohol copolymer concentration of 0.2 wt %, a weight average molecular weight of 13,000 to 23,000 g/mole and a degree of hydrolysis of 87 to 89 mole percent has carbon doped oxide (CDO) removal rate of 148 Angstroms/minute while Slurry 8, which has a higher molecular weight polyvinylalcohol copolymer (all other factors being constant) shows a removal rate of 238 Angstroms/minute. Quite clearly from Table 7, varying either the molecular weight or the degree of hydrolysis would permit control of the removal rate of the low-k and ultra-low-k dielectric layer.

From Examples 1 and 2 it may be seen that the polishing composition containing polyvinylalcohol copolymer may advantageously reduce the removal rate of the metal interconnect and the low-k dielectric to less than or equal to about 150 Angstroms/minute.

The above solutions can have stability issues when stored for several days at room temperature. Preferably, adding the solution as a two-part or point-of-use mixture eliminates the stability issues. In particular, the polyvinyl alcohol is most preferably part of one solution and the remaining ingredients part of another solution. Alternatively, lowering the solution's pH or locating a more stable polyvinylalcohol copolymer could also further stabilize the solution.

1. An aqueous polishing composition for polishing semiconductor substrates comprising:
0.001 to 2 wt % of a polyvinylalcohol copolymer, the polyvinylalcohol copolymer having a first component, a second component and a weight average molecular weight of 1,000 to 1,000,000 grams/mole, and the first component being 50 to 95 mole percent vinyl alcohol and the second component being more hydrophobic than the vinyl alcohol and 0.05 to 50 wt % silica abrasive particles; and the composition having a pH of 8 to 12.

2. The composition of claim 1, wherein the polishing composition has 0.01 to 1.7 wt % polyvinylalcohol copolymer.

3. The composition of claim 1, wherein the polyvinylalcohol copolymer has a weight average molecular weight of 13,000 to 23,000 grams per mole.

4. The composition of claim 1, wherein the polyvinylalcohol copolymer has a degree of hydrolysis between 70 and 90 mole percent.

5. The composition of claim 1, further comprising thermoplastic polymers, wherein the thermoplastic polymers are polyacetals, polyacrylics, polycarbonates, polystyrenes, polyesters, polyamides, polyamideimides, polyarylates, polyarylsulfones, polyethersulfones, polyphenylene sulfides, polysulfones, polyimides, polyetherimides, polytetrafluoroethylenes, polyetherketones, polyether etherketones, polyether ketone ketones, polybenzoxazoles, polyoxadiazoles, polybenzothiazinophenothiazines, polybenzothiazoles, polypyrazinoquinoxalines, polypyromellitimides, polyquinoxalines, polybenzimidazoles, polyoxindoles, polyoxoisoindolines, polydioxoisoindolines, polytriazines, polypyridazines, polypiperazines, polypyridines, polypiperidines, polytriazoles, polypyrazoles, polycarboranes, polyoxabicyclononanes, polydibenzofurans, polyphthalides, polyacetals, polyanhydrides, polyvinyl ethers, polyvinyl thioethers, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or a mixture comprising at least one of the foregoing thermoplastic polymers.

6. The composition of claim 5, wherein the thermoplastic polymers have a weight average molecular weight of 1,000 to 1,000,000 grams per mole.

7. An aqueous polishing composition for polishing semiconductor substrates comprising:
0.01 to 1.7 wt % of a polyvinylalcohol-polyvinylacetate copolymer, the polyvinylalcohol-polyvinylacetate copolymer having 60 to 90 mole percent vinyl alcohol and a weight average molecular weight of 1,000 to 1,000,000 grams/mole, 0 to 10 wt % corrosion inhibitor, 0 to 10 wt % oxidizing agent, 0 to 20 wt % complexing agent and 0.1 to 40 wt % silica abrasive particles; and the composition having a pH of 8 to 11.

8. A method of polishing a semiconductor substrate comprising: applying an aqueous polishing composition of 0.001 to 2 wt % of a polyvinylalcohol copolymer, the polyvinylalcohol copolymer having a first component, a second component and a weight average molecular weight of 1,000 to 1,000,000 grams/mole, and the first component being vinyl alcohol and the second component being more hydrophobic than the vinyl alcohol and 0.05 to 50 wt % silica abrasive particles; and the composition having a pH of 8 to 12; and
polishing the semiconductor substrate at a pad pressure less than or equal to 21.7 kiloPascals.

9. The method of claim 8, wherein the polishing composition facilitates a removal rate of less than or equal to 150 Angstroms/minute for a low-k dielectric layer.

10. The method of claim 8, wherein the polyvinylalcohol copolymer is a polyvinylalcohol-polyvinylacetate copolymer.
